(19) United States
(12) Patent Application Publication
(10) Pub. No.: US 2011/0246506 A1
(43) Pub. Date: Oct. 6, 2011

(54) SENSOR INFORMATION MANAGEMENT SYSTEM AND SENSOR INFORMATION MANAGEMENT METHOD

(75) Inventors: Michiki NAKANO, Tokyo (JP); Daisuke KOMAKI, Yokohama (JP); Atsushi HONZAWA, Kawasaki (JP)

(73) Assignee: Hitachi, Ltd.

(21) Appl. No.: 13/021,209

(22) Filed: Feb. 4, 2011

(30) Foreign Application Priority Data
Apr. 6, 2010 (JP) 2010-087713

(51) Int. Cl. G06F 17/30

(52) U.S. Cl. 707/769; 707/E17.014

(57) ABSTRACT

An object of the present invention is to manage various containment relationships such as packing relationships and loading relationships of an article, to efficiently search for sensor information measured by a sensor associated with the article, and thereby to provide the sensor information to the user. A system 100 includes a relationship information registration part 1001 and a sensor information searching part 1002. The relationship information registration part 1001: registers relationship information in a relationship information table; searches a root information table by using as a key a lower layer identifier in paired identifiers shown by the relationship information to find a dependent identifier having the lower layer identifier as an upper layer identifier thereof; searches the root information table by using as a key an upper layer identifier in the paired identifiers to find corresponding root information; and registers the found root information as root information of the dependent identifier in the root information table. The sensor information searching part 1002: receives, from an external terminal or the like, a reference request for sensor information of a transport objector transportation unit; obtains, from the root information table, an identifier located at the highest position in all the relationships with the transport object or transportation unit; obtains, from the sensor information table, sensor information by using the obtained identifier as a key; and outputs, to the external terminal or the like, the sensor information as sensor information of the transport object or transportation unit.

### CROSS-REFERENCE TO RELATED APPLICATIONS

The present application claims the benefit of priority from Japanese Patent Application No. 2010-87713 filed on Apr. 6, 2010, the content of which is herein incorporated by reference.

### BACKGROUND OF THE INVENTION

1. Field of the Invention

The present invention relates to a sensor information management system and a sensor information management method. Specifically, the present invention relates to a technique which enables management of various containment relationships such as a packing relationship and a loading relationship of an article, and efficiently searching for sensor information measured by a sensor associated with the article thereby to provide the sensor information to a user.

2. Related Art

In recent years, there is an increasing need for sensors in various fields. For example, in a logistics field, the temperature history or the moving route of a cargo is visualized by use of a temperature-humidity sensor, a positioning sensor or an acceleration sensor attached to the cargo, and thereby is utilized to improve business. However, attaching a sensor to each cargo requires a huge investment for sensor introduction.

To cope with such a problem, there is proposed a technique such as one using an environment information management system (see United States Patent Application Publication No. US2006/0271392) in which a history of an environment such as a temperature history or humidity history of each article on a distribution stage is obtained by a reusable measurement instrument attached to the article or a measurement instrument installed in a room or the like.

### SUMMARY OF THE INVENTION

With the related art as described above, an environment history, such as the temperature history or the humidity history, of each article can be obtained by utilizing measurement values of an environment information acquiring instrument, such as a temperature sensor or a humidity sensor, which is installed at a specific place such as a warehouse, a factory or a truck bed. However, in a case where an article has various containment relationships such as packing and loading relationships, such as a case where the article is transported in a state of being packaged in a case placed on a pallet put in a container loaded on a truck, it is not possible to efficiently obtain environment information associated with the article.

Hence, an object of the present invention is to provide a technique capable of managing various containment relationships and the like of an article, such as a packing relationship and a loading relationship, and efficiently searching for sensor information measured by a sensor associated with the article thereby to provide the sensor information to a user.

A sensor information management system according to the present invention to solve the aforementioned problem is a computer system for managing sensor information measured by a sensor, and the sensor information management system includes

a storage unit in which a relationship information table, a root information table and a sensor information table are stored,

the relationship information table being configured to hold relationship information on one of packing and loading relationship and an installation relationship between a transport object, a transportation unit capable of packing, loading or transporting the transport object, and a sensor installed on one of the transport object and the transportation unit, the relationship information including information on a hierarchy of identifiers associated with respective objects establishing the relationship,

the root information table being configured to hold root information on each upper layer and lower layer identifier pair establishing one of the packing and loading relationship and the installation relationship, an identifier at the highest layer in one of the packing and loading relationship and the installation relationship being taken as the upper layer identifier and set as the root information, and

the sensor information table being configured to hold an identifier of the sensor and a history of sensor information measured by the sensor associated with the identifier.

In addition, the sensor information management system includes a relationship information registration part configured to receive, upon occurrence of a change in one of the packing and loading relationship and the installation relationship, the relationship information on one of the packing and loading relationship and the installation relationship in which the change has occurred, from one of an input unit and an external terminal via a communication unit, register the relationship information into the relationship information table, perform a search on the root information table using a key the lower layer identifier in the pair of identifiers indicated by the received relationship information a key, specify a dependant identifier having the lower layer identifier as an upper layer identifier thereof, specify corresponding root information by performing a search on the root information table using the upper layer identifier in the pair of identifiers as a key, and register the specified root information into the root information table as root information of the dependent identifier.

Further, the sensor information management system includes a sensor information searching part configured to receive a reference request for sensor information corresponding to one of a certain transport object and a certain transportation unit, the reference request being received from one of the input unit and the external terminal via the communication unit, obtain an identifier located at the highest layer among identifiers related with the transport object or the transportation unit, the identifier being obtained from the root information table, obtain the sensor information from the sensor information table with the obtained identifier being a key, and output the sensor information as the sensor information on one of the transport object and the transportation unit to one of an output unit or the external terminal via the communication unit.

A sensor information management method for managing sensor information measured by a sensor according to the present invention is performed by a computer system provided with a storage unit in which a relationship information table, a root information table and a sensor information table are stored, the relationship information table being configured to hold relationship information on one of packing and loading relationship and an installation relationship between a transport object, a transportation unit capable of packing, loading or transporting the transport object, and a sensor installed on one of the transport object and the transportation unit, the relationship information including information on a hierarchy of identifiers associated with respective objects establishing the relationship, the root information table being configured to hold root information on each upper layer and lower layer identifier pair establishing one of the packing and loading relationship and the installation relationship, an identifier at the highest layer in one of the packing and loading relationship and the installation relationship being taken as the upper layer identifier and set as the root information, and the sensor information table being configured to hold an identifier of the sensor and a history of sensor information measured by the sensor associated with the identifier.

Specifically, the method causes the computer system to perform a process of receiving, upon occurrence of a change in one of the packing and loading relationship and the installation relationship, the relationship information on one of the packing and loading relationship and the installation relationship in which the change has occurred, from one of an input unit and an external terminal via a communication unit, registering the relationship information into the relationship information table, performing a search on the root information table using a key the lower layer identifier in the pair of identifiers indicated by the received relationship information a key, specifying a dependant identifier having the lower layer identifier as an upper layer identifier thereof, specifying corresponding root information by performing a search on the root information table using the upper layer identifier in the pair of identifiers as a key, and registering the specified root information into the root information table as root information of the dependent identifier.

In addition, the computer system performs a process of receiving a reference request for sensor information corresponding to one of a certain transport object and a certain transportation unit, the reference request being received from one of the input unit and the external terminal via the communication unit, obtaining an identifier located at the highest layer among identifiers related with the transport object or the transportation unit, the identifier being obtained from the root information table, obtaining the sensor information from the sensor information table with the obtained identifier being a key, and outputting the sensor information as the sensor information on one of the transport object and the transportation unit to one of an output unit or the external terminal via the communication unit.

Note that when a dependent identifier having the lower layer identifier as the upper layer identifier thereof is located, it is more preferable that the dependent identifier be one having the highest identifier as the upper layer identifier thereof.

The present invention makes it possible to manage various containment relationships and the like of an article, such as a packing relationship and a loading relationship, and to efficiently search for sensor information measured by a sensor associated with the article thereby to provide the sensor information to the user.

### BRIEF DESCRIPTION OF THE DRAWINGS

FIG. 1 is a network configuration diagram including a sensor information management system in an embodiment;

FIG. 2 is an example of data held by a storage device of a sensor information server in the embodiment;

FIG. 3 is an example of a data model handled by a relationship information table in the embodiment;

FIG. 4 is an example of a data model handled by a root information table in the embodiment;

FIG. 5 is a block diagram showing a functional configuration of the sensor information server in the embodiment;

FIG. 6 is a table showing a configuration example of the relationship information table in the embodiment;

FIG. 7 is a table showing a configuration example of the root information table in the embodiment;

FIG. 8 is a table showing a configuration example of the sensor information table in the embodiment;

FIG. 9 is a flowchart showing Process Flow Example 1 of a sensor information management method in the embodiment;

FIG. 10 is a flowchart showing Process Flow Example 2 of a sensor information management method in the embodiment;

FIG. 11 is a flowchart showing Process Flow Example 3 of a sensor information management method in the embodiment;

FIG. 12 is a flowchart showing Process Flow Example 4 of a sensor information management method in the embodiment;

FIG. 13 is a flowchart showing Process Flow Example 5 of a sensor information management method in the embodiment;

FIG. 14 is a flowchart showing Process Flow Example 6 of a sensor information management method in the embodiment;

FIG. 15 is a table showing an example of information obtained in Step S401;

FIG. 16 is a table showing an example of information obtained by a sensor information searching part;

FIG. 17 is an example of data held by the storage device of a sensor information server in a second embodiment;

FIG. 18 is a table showing an example of a structure of an ID-type initial-value table;

FIG. 19 is a process flow example in a case where a determination result in Step S3042 is “absent”; and

FIG. 20 is a process flow example of processing up to Step S3062 in the second embodiment.

### DETAILED DESCRIPTION OF THE INVENTION

### First Embodiment

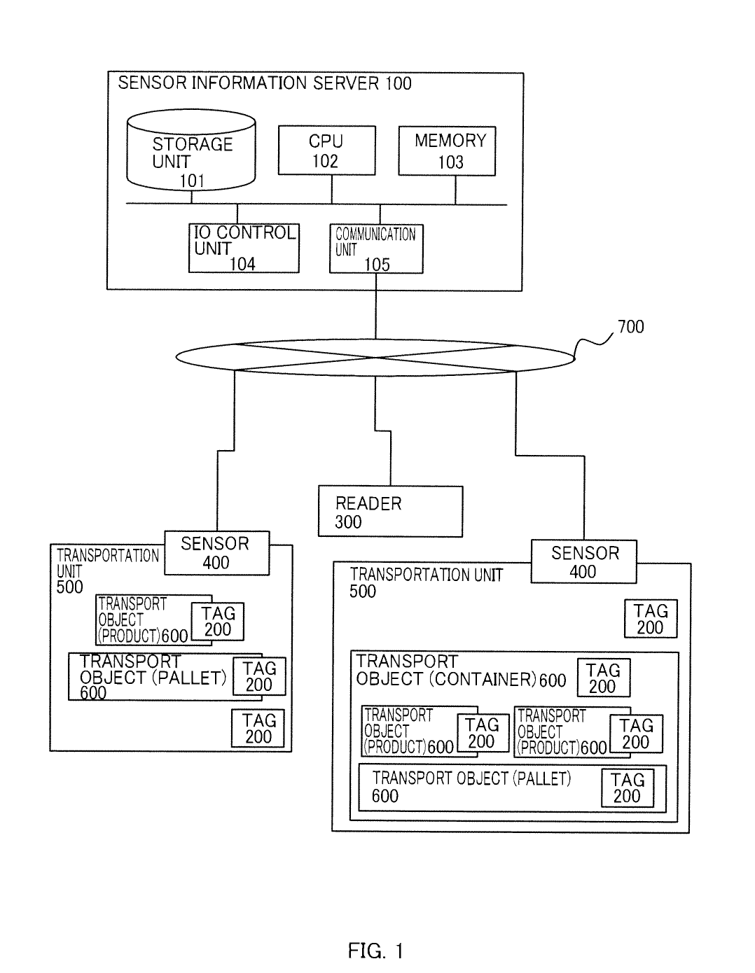

Hereinafter, a detailed description will be given of an embodiment of the present invention by use of the accompanying drawings. FIG. 1 is a network configuration example including a sensor information management system of the present embodiment. The sensor information management system is intended to be a sensor information server 100 but may include a reader 300 and a sensor 400 as in the network configuration shown in FIG. 1. As a network 700, any network such as the Internet or LAN may be adopted depending on the situation, regardless of wired or wireless network.

The sensor information server 100 is a server device which accumulates and manages installation information, relationship information, sensor information, and the like and provides the user with various types of information. The installation information indicates what the sensor 400 is attached to. The relationship information indicates a configuration state of products, pallets, containers and the like, each of which being a transport object 600. The sensor information is obtained from measurements by a positioning sensor, an acceleration sensor, and the like. Through an IO (input-output) control unit 104 or a communication unit 105, the various types of information accumulated in the sensor information server 100 is provided to a system administrator and users in the logistics industry or the like, or to other systems. The sensor information server 100 naturally as a server device includes: a non-volatile storage unit 101, such as a hard disk drive; a CPU 102 which reads programs from the storage unit 101 and executes the programs to implement necessary function parts; a volatile memory 103, such as a RAM; the IC control unit 104, such as a keyboard, a mouse or a display, which provides information to a user and receives instructions; and the communication unit 105 which communicates with other apparatuses through the network 700.

In this embodiment, sensor information pieces are associated with transport objects 600 and transportation units 500, and tags 200 are attached thereto. The tags 200 are attached to the transportation units 500, such as a truck and a folk lift, and transport objects 600, such as a product, a pallet, and a container, and are used as a means of identifying the objects individually. The tags 200 may be, for example, an RFID, a barcode, a two-dimensional code and the like.

In contrast, it is a reader 300 that executes a reading operation on the tags 200. The reader 300 operates, for example, in a case where a product is stacked on the pallet, a container is loaded on the truck, the product is taken out of the pallet, the container is taken out of the truck, or the like. The reader 300 reads IDs stored in the tags 200 of a side to be contained (e.g., the product or the container) as a result of packing or loading and of a containing side (e.g., the pallet or the truck), respectively. The reader 300 transmits the read-out IDs of the included side and the including side, reading date and time, an identifier indicating start and end of the containment relationship, and a relationship type such as “sensor installation” or “packing” to the sensor information server 100 through the network 700. In this respect, the reader 300 as a matter of course includes a communication unit, necessary computation units, a memory, and the like.

Note that the reader 300 may be configured in such a manner that different readers 300 operate depending on the use state. For example, one of the readers 300 may be used at the start of the containment relationship, that is, in a case where products or the like are loaded on the pallet or a sensor is attached to the pallet, and another one may be used at the end of the containment relationship, that is, in a case where products or the like are taken off from the pallet. In this case, the reader 300 to be used at the start of the containment relationship is configured to transmit, in response to reading of a tag 200, an identifier indicating the start of the containment relationship and information on the relationship type in addition to data such as the read-out ID, to the sensor information server 100. In contrast, the reader 300 to be used at the end of the containment relationship is configured to transmit, in response to reading of the tag 200, an identifier indicating the end of the containment relationship and information on the relationship type in addition to data such as the read-out ID, to the sensor information server 100.

Each of the readers 300 operating in such a manner may be installed at places at which corresponding use states are indicated and may operate autonomously. Alternatively, users at places where works such as loading and unloading are performed may use the readers 300 depending on respective usages. Still alternatively, the users may directly input or check the identifiers indicating the start and end of the containment relationship and information on the relationship type by using (an IO control device) of the readers 300.

On the other hand, the sensor 400 is attached to any of the transport objects 600 and the transportation units 500 and transmits a measured sensor information piece, the measurement date and time, and a sensor-unique ID (hereinafter, a sensor ID) to the sensor information server 100 through the network 700. In this respect, the sensor 400 as a matter of course includes a communication unit, necessary computation units, a memory, and the like. It is conceivable that it is difficult to always couple the sensor 400 to the network 700 and thereby to occasionally transmit the sensor information piece to the sensor information server 100. In this case, the sensor 400 may be configured to accumulate the sensor information pieces in an appropriate storage area such as its memory and collectively transmit the accumulated sensor information pieces to the sensor information server 100 at the timing when the sensor 400 is successfully coupled to the network 700.

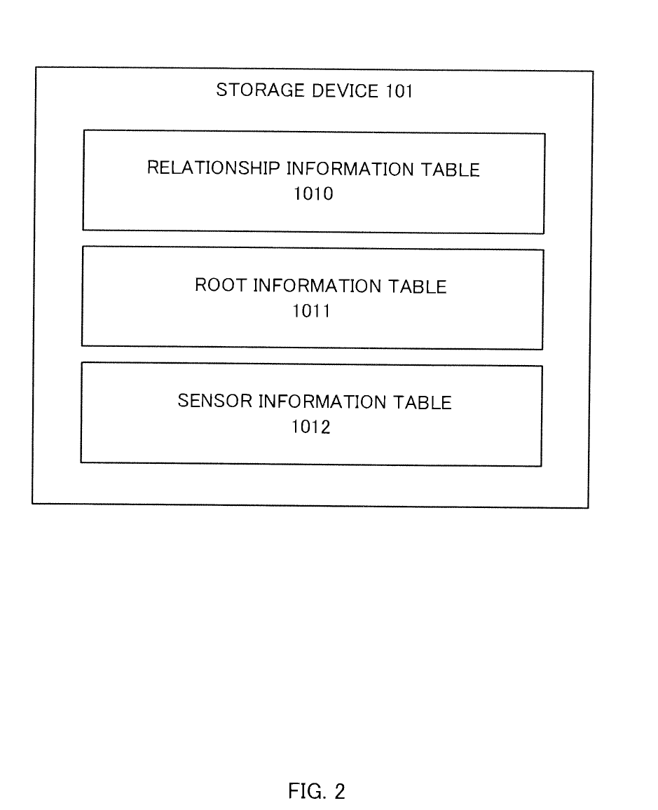

FIG. 2 shows data held by the storage unit 101 in the sensor information server 100. The storage unit 101 holds a relationship information table 1010, a root information table 1011, and a sensor information table 1012.

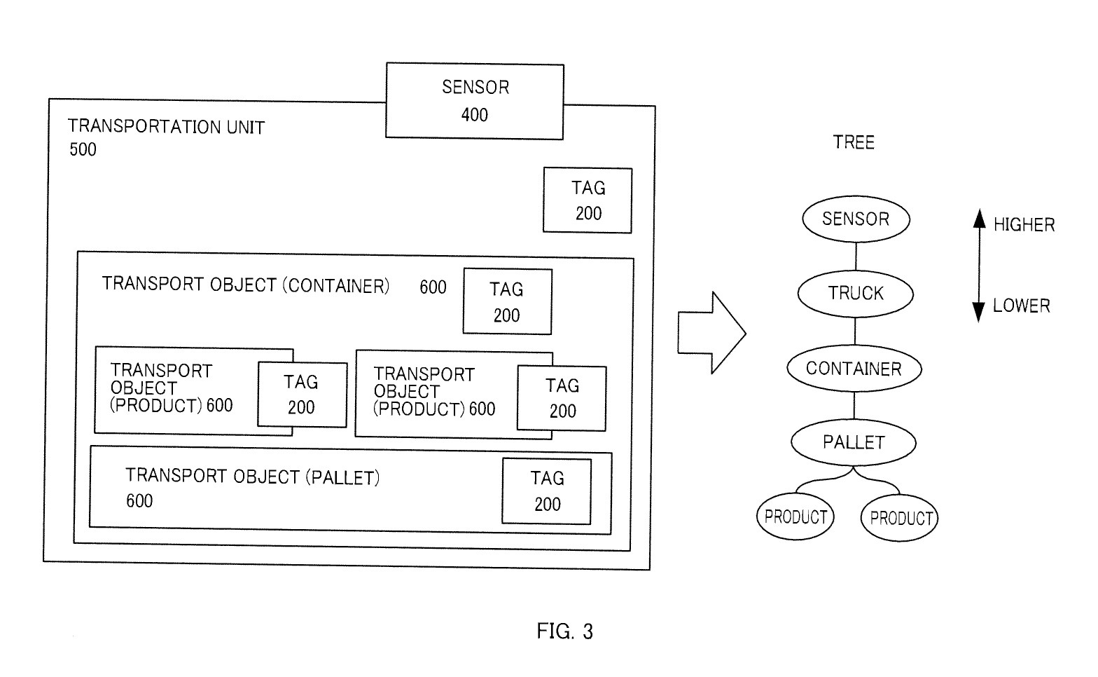

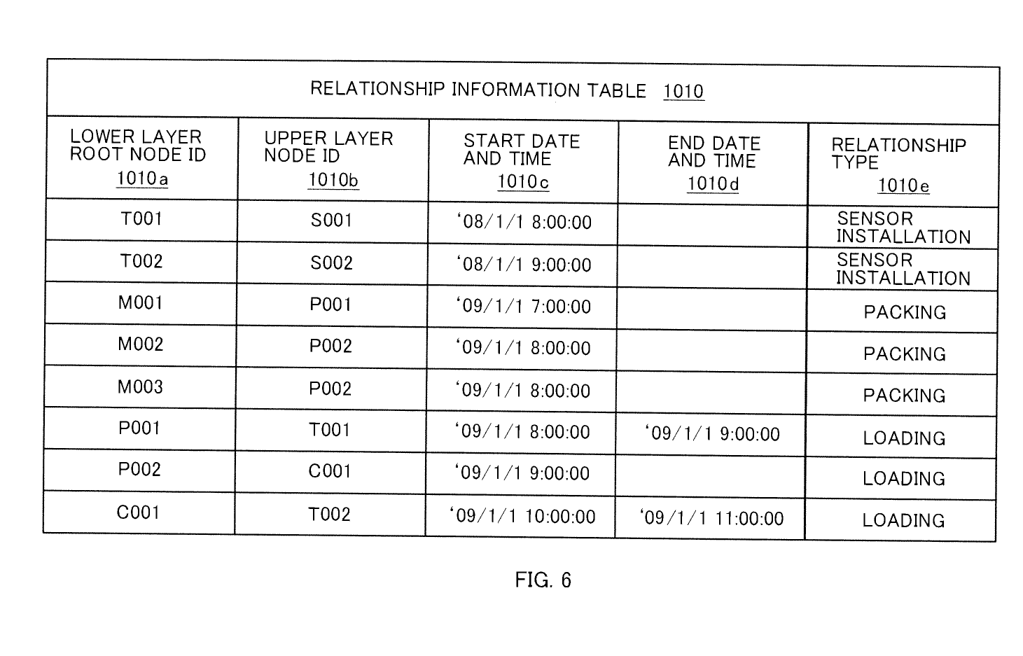

The relationship information table 1010 holds information indicating a containment relationship (=a packing and loading relationship or an installation relationship) for a relationship between transport objects 600, a relationship between a transport object 600 and a transportation unit 500, a relationship between a transportation unit 500 and a sensor 400, or the like. For example, information is held which indicates a time period during which a product is stacked on a pallet, a time period during which a pallet is loaded in a container, a time period during which a sensor is attached to a truck, and the like. The relationship information table 1010 handles a series of containment relationships as a model in a tree structure. For example, as shown in the left part of FIG. 3, in a case where products are loaded on a pallet, the pallet is placed in a container, and the container is loaded on a truck, such a hierarchical relationship, i.e., a configuration relationship, can be handled as a model in a tree structure shown in the right part of FIG. 3. Hereinafter, a collective configuration such as “product-pallet” or “product-pallet-container” is referred to as a tree; an included side is referred to as a lower layer tree; and an including side is referred to as an upper layer tree. In addition, a root node of a lower layer tree is referred to as a lower layer root node, and a node to which the lower layer root node is attached and which belongs to an upper layer tree is referred to as an upper layer node. The structure of the relationship information table 1010 is shown in FIG. 6, which will be described later.

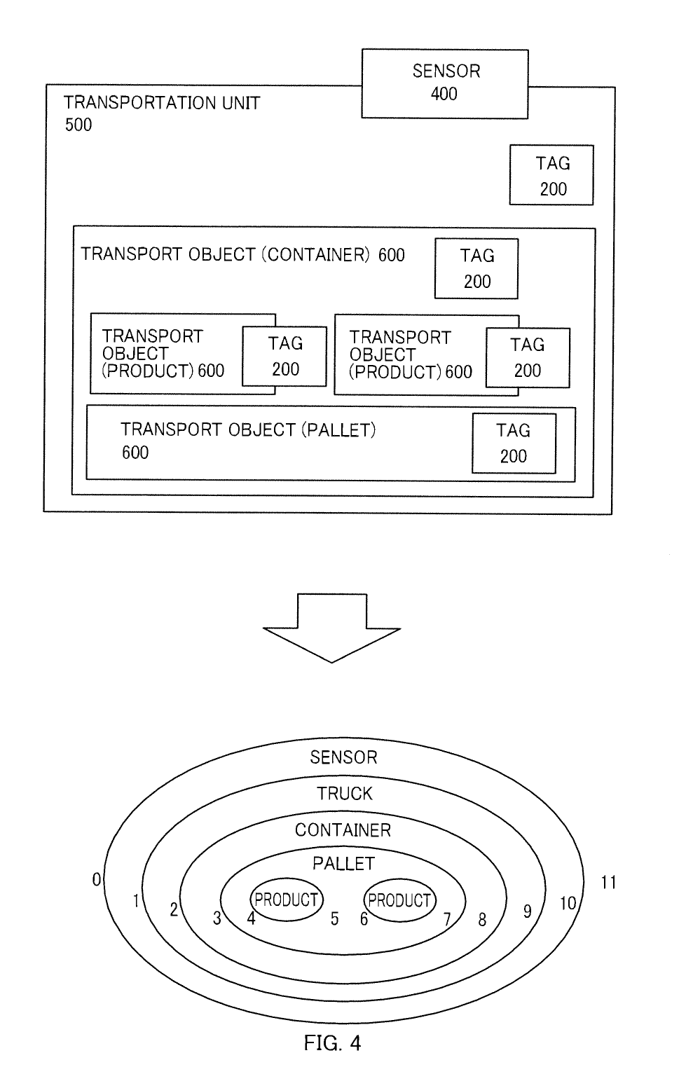

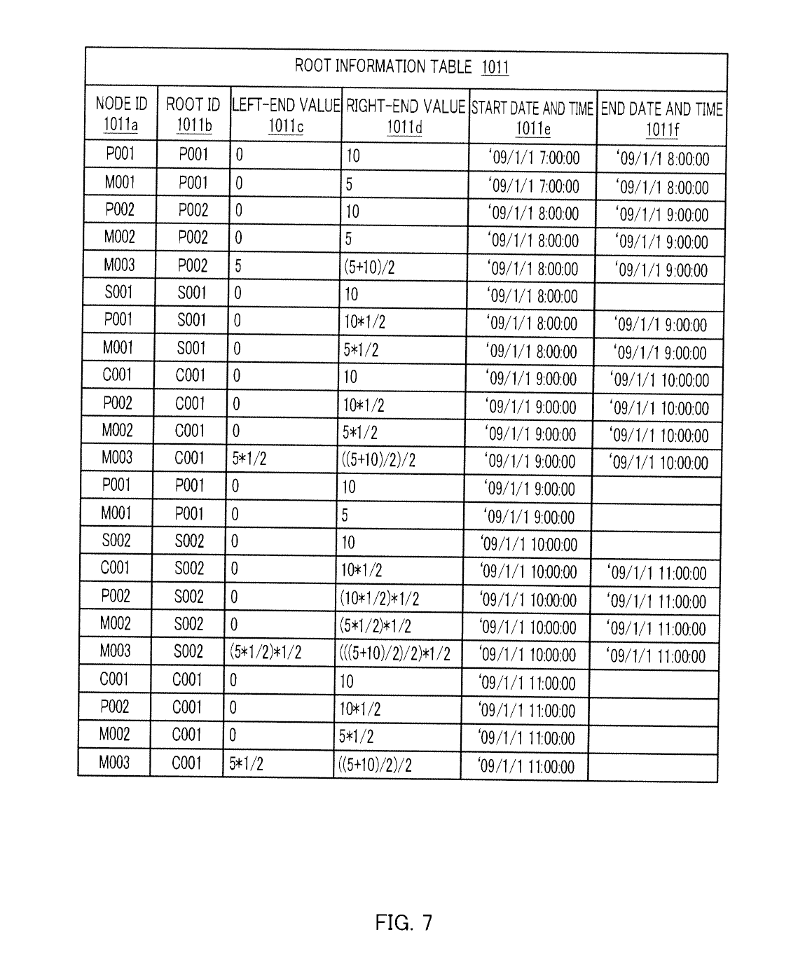

Further, the root information table 1011 holds information on a highest layer node of a tree to which each of a transport object 600, a transportation unit 500, and a sensor 400 belongs, and information indicating from when and until when the node has belonged to the tree. The root information table 1011 handles the tree structure described with reference to FIG. 3 by using a model of containment relationship of nodes as shown in FIG. 4. For example, as shown in an upper part of FIG. 4, in a case where products are stacked on a pallet, the pallet is included in a container, and the container is loaded on a truck, the structure relationship is handled as a model of node containment relationship shown in a lower part of FIG. 4. As shown in the lower part of FIG. 4, values are given to each node at its right and left ends, respectively (the higher the layer, the higher the initial value), and the node containment relationships are managed based on the magnitude of the values. Hereinafter, a value at the left end of the node is referred to as a left-end value, and a value at the right end is referred to as a right-end value. The structure of the root information table 1011 is shown in FIG. 7, which will be described later.

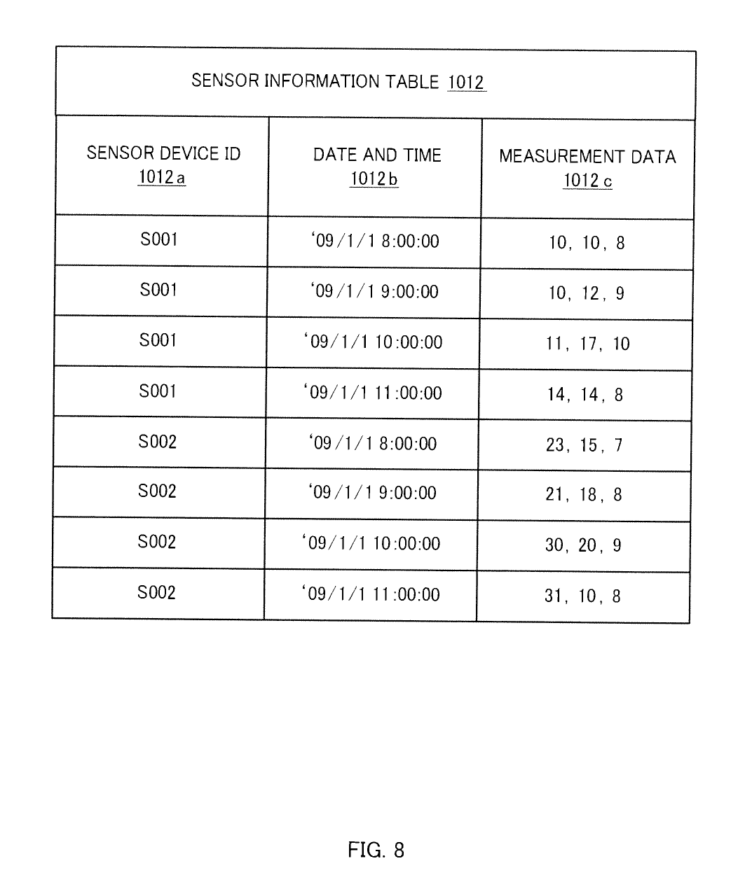

The sensor information table 1012 holds results of measurements by the sensor 400. The structure of the sensor information table 1012 is shown in FIG. 8, which to be described later.

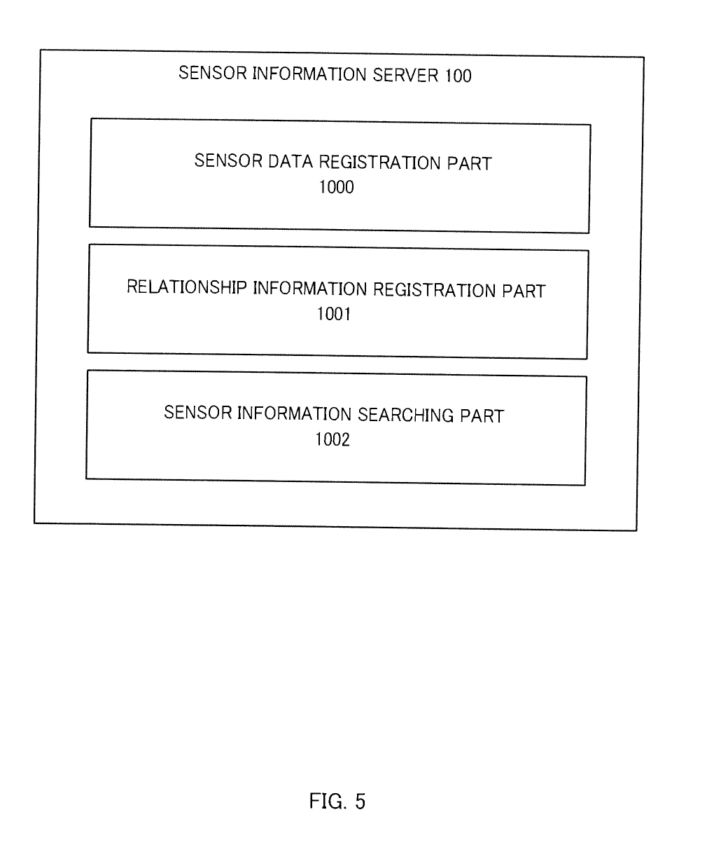

Now, a description is given of function parts provided in the sensor information server 100. FIG. 5 is a diagram showing a functional configuration of the sensor information server 100. The sensor information server 100 includes a sensor data registration part 1000, a relationship information registration part 1001, and a sensor information searching part 1002. Each part is implemented by executing a program held in the storage unit 101, by the CPU 102.

The sensor data registration part 1000 has a function of registering results of measurements by the sensors 400 into the sensor information table 1012. Specifically, the sensor data registration part 1000 receives a sensor information piece obtained by measurement, the measurement date and time and a sensor ID as an input and registers the sensor information piece into the sensor information table 1012.

The relationship information registration part 1001 has a function of registering a configuration relationship such as “product-pallet” or “pallet-container.” Specifically, in a case where a change has occurred in one of the packing/loading relationship and the installation relationship, the relationship information registration part 1001 receives a relationship information piece (including an ID of a lower layer root node, an ID of an upper layer node, a read-out date and time of the ID, an identifier indicating start or end of the relationship, and a relationship type) of the one of the packing and loading relationship and the installation relationship in which the change has occurred. The relationship information registration part 1001 then stores the relationship information piece into the relationship information table 1010. The relationship information registration part 1001 also registers a root information piece into the root information table 1011.

The root information piece is registered in the following manner. Specifically, a search is performed on the root information table 1011 using a lower layer identifier of a pair of identifiers indicated by the received relationship information a key and a dependent identifier which has the lower layer identifier as its upper layer identifier is specified. Then, a search is performed on the root information table 1011 using an upper layer identifier of the pair of identifiers a key and a root information piece of the upper layer identifier is specified. The root information thus specified is registered into the root information table 1011 as root information of the dependent identifier. At this time, it is more preferable that the highest layer identifier is taken as the upper layer identifier.

Alternatively, it is preferable that the relationship information registration part 1001 perform a registration process in the following manner. Specifically, the relationship information registration part 1001 performs a search on the relationship information table 1010 with respect to a lower layer identifier and an upper layer identifier included in a relationship information piece to be registered and obtains a relationship type information piece. Then, based on the obtained relationship type information piece, the relationship information registration part 1001 determines whether or not objects of the lower layer identifier and the upper layer identifier have a sensor installed thereon. If the lower layer identifier or the upper layer identifier is determined as having a sensor thereon, the identifier is replaced with an identifier of the corresponding sensor, and a root information piece is registered into the root information table 1011.

In addition, the relationship information registration part 1001 maybe configured to register root information into the root information table 1011 in the following manner. Specifically, the relationship information registration part 1001 receives the relationship information piece of one of the packing and loading relationship and the installation relationship in which the change has occurred. In a case where the relationship type information piece in the relationship information piece indicates that the object of the lower layer identifier is attached, e.g., packed, loaded, contained or the like, to an object of the upper layer identifier, a search is performed on the root information table 1011 with the lower layer identifier being a key and a dependent identifier having the lower layer identifier as its upper layer identifier is located. Then, for the lower layer identifier and the dependent identifier, a relationship end date and time indicated as one of relationship period columns in the root information table 1011 is updated with the date and time of attachment indicated by the corresponding relationship information piece. Subsequently, a search is performed on the root information table 1011 using the upper layer identifier as a key, and a root information piece is specified. The root information piece thus specified may be registered into the root information table 1011 as a root information piece of the lower layer identifier and the dependent identifier. At this time, it is more preferable that the highest layer identifier be used as the root information piece.

The relationship information registration part 1001 maybe configured to register a lower layer identifier into the root information table 1011 in the following manner. Specifically, the relationship information registration part 1001 receives the relationship information piece of the packing/loading relationship or the installation relationship in which the change has occurred. If the relationship type information piece in the relationship information piece indicates that the object of the lower layer identifier is detached from an object of the upper layer identifier by unpacking, unloading or the like, a search is performed on the root information table 1011 using the lower layer identifier as a key and a dependent identifier having the lower layer identifier as its upper layer identifier is specified. Then, for the lower layer identifier and the dependent identifier, a relationship end date and time indicated as one of relationship period columns in the root information table 1011 is updated with the date and time of detachment indicated by the corresponding relationship information piece. Subsequently, the lower layer identifier is registered into the root information table 1011 as a root information piece of the lower layer identifier and the dependent identifier. At this time, it is more preferable that the highest identifier be used as the upper layer identifier.

Note that the detail of a process flow executed by the aforementioned relationship information registration part 1001 will be described later.

The sensor information searching part 1002 has a function of searching for a piece of sensor information related to a transport object 600, a transportation unit 500, and a sensor 400. The sensor information searching part 1002 receives a sensor information reference request (including an ID of an object to be searched for and a date and time showing a time period to be searched for) from the IO control unit 104 or the external terminal via the communication unit 105 and obtains an identifier located at the highest layer in the relationship for the transport object 600 or the transportation unit 500 from the root information table 1011. The sensor information searching part 1002 then obtains a sensor information piece from the sensor information table 1012 by using the obtained identifier as a key, and then outputs the sensor information piece as a sensor information piece of the transport object 600 or the transportation unit 500 to the IO control unit 104 or the external terminal via the communication unit 105. The detail of a process flow executed by the sensor information searching part 1002 will be described later.

### TABLE CONFIGURATION EXAMPLE

Subsequently, a description is given of the detail of the tables used by the sensor information server 100. FIG. 6 shows a configuration example of the relationship information table 1010. The relationship information table 1010 includes a set of records each including a lower layer root node ID 1010a, an upper layer node ID 1010b, a start date and time 1010c, an end date and time 1010d, and a relationship type 1010e.

As the lower layer root node ID 1010a, an ID stored in a tag 200 attached to an object on a contained side is set. In contrast, as the upper layer node ID 1010b, an ID stored in a tag 200 attached to an object on a containing side is set. As the start date and time 1010c, the date and time at which the reader 300 has read the tags 200 at the time when the object on the contained side has been attached to the object on the containing side is set. As the end date and time 1010d, the date and time at which the reader 300 has read the tags 200 at the time when the object on the included side has been detached from the object on the including side is set. A null value of the end date and time 1010d shows that the relationship is still continuing. In other words, the tag is still attached to an object at present. As the relationship type 1010e, a relationship type is set. For example, in a case of attaching a sensor 400 to a transportation unit 500, “sensor installation” or the like is set as the relationship type 1010e.

FIG. 7 shows a configuration example of the root information table 1011. The root information table 1011 includes a set of records including a node ID 1011a, a root ID 1011b, a left-end value 1011c, a right-end value 1011d, a start date and time 1011e, and an end date and time 1011f. As the node ID 1011a, an ID stored in a tag 200 attached to an object is set. As the root ID 1011b, an ID stored in a tag 200 attached to an object located at the highest layer in a tree to which the object belongs is set. As the left-end value 1011c, a left-end value of the node size of the object is set. As the right-end value 1011d, a right-end value of the node size of the object is set. As the start date and time 1011e, the date and time at which the object has started belonging to the tree is set. As the end date and time 1011f, the date and time at which the object has been removed from the tree is set.

The root information table 1011 is capable of holding, for each object, a root ID that is the highest layer node in the tree to which the object belongs and makes it possible to search for a sensor 400 installed on a transportation unit 500 for an object for which a sensor information is needed. Thus, sensor information for any object can be obtained without having to install the sensor 400 on every object.

FIG. 8 shows a configuration example of the sensor information table 1012. The sensor information table 1012 includes a set of records including a sensor device ID 1012a, date and time 1012b, and a measurement data piece 1012c. As the sensor device ID 1012a, a sensor ID assigned to the sensor 400 is set. As the date and time 1012b, the date and time at which the sensor 400 has made a measurement is set. As the measurement data piece 1012c, a data piece measured by the sensor 400 is set. The measurement data piece 1012c shown in the sensor information table 1012 in FIG. 8 shows an example in which a three-dimensional coordinate data piece is stored in a case where the sensor 400 is a positioning sensor. In a case where the measurement data piece is a multi-dimensional data piece, values of the respective dimensions may be stored in respectively provided columns, although the columns are not shown in FIG. 8.

### Process Flow Example 1

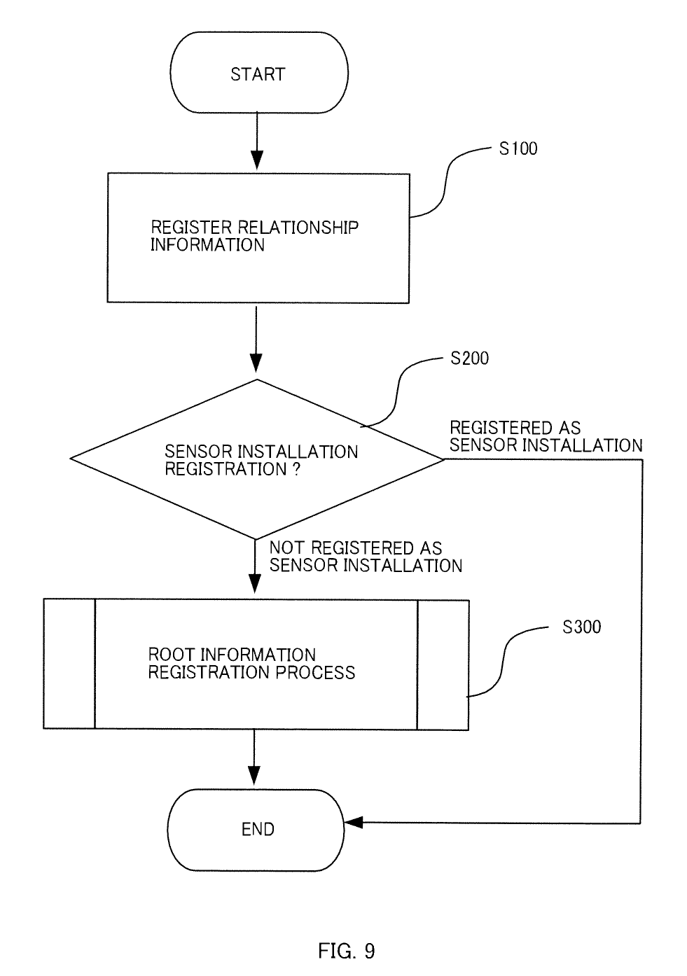

Next, a description is given of a process flow example of a sensor information management method of this embodiment. FIG. 9 shows a process flow which is Process Flow Example 1 of the sensor information management method, the process flow being executed by the relationship information registration part 1001. The relationship information registration part 1001 receives a relationship information piece (including data piece such as a lower layer root node ID, an upper layer node ID, a date and time of reading of the lower layer root node ID or the upper layer node ID, an identifier indicating start or end of the relationship, and a relationship type) from the IO control unit 104 or the reader 300 and registers the relationship information piece received from the IO control unit 104 or the reader 300, in the relationship information table 1010 (S100). An example of the registered relationship information piece is as shown in FIG. 6.

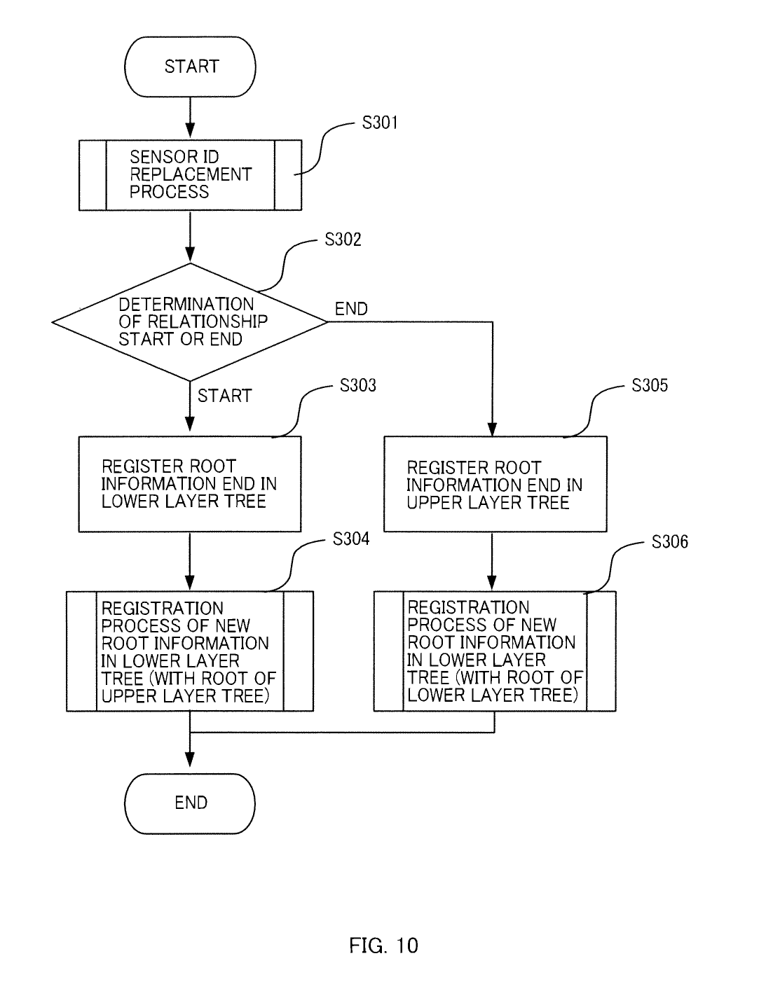

Subsequently, based on a value of the relationship type obtained in Step S100, the relationship information registration part 1001 determines whether or not the registration of the relationship information piece is due to sensor installation (S200). For example, suppose a case where the relationship type for installation of the sensor is “sensor installation.” If the value of the relationship type indicated by the relationship information piece is “sensor installation” (S200: registered as sensor installation), the relationship information registration part 1001 terminates the flow. On the other hand, if the value of the relationship type indicated by the relationship information is not “sensor installation” (S200: not registered as sensor installation), the relationship information registration part 1001 proceeds to a root information registration process (S300). A process flow of the root information registration process S300 is be shown in FIG. 10, which will be described later.

### Process Flow Example 2

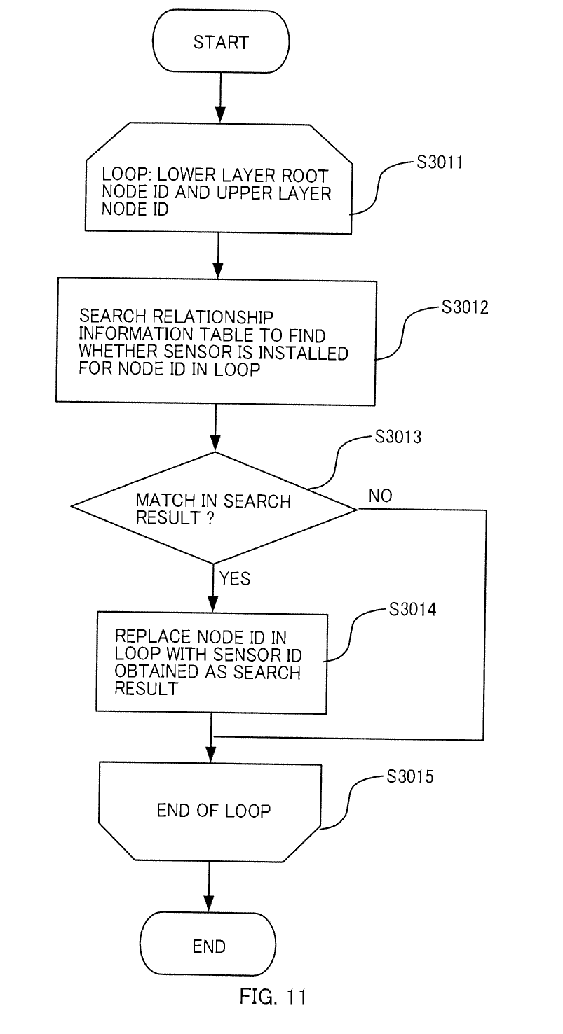

Next, a description is given of the root information registration processing S300. FIG. 10 shows the process flow. In this case, the relationship information registration part 1001 looks up in the relationship information table 1010 to check if a sensor is attached to an object of the lower layer root node ID or the upper layer node ID received as the relationship information piece by the relationship information registration part 1001 in sensor ID replacement process (S301). If a sensor is attached to the object, a node ID of the object is changed to an ID of the sensor. On the other hand, if a sensor is not attached to the object, the process proceeds to Step S302 which is the next process. A process flow of the sensor ID replacement process (S301) is shown in FIG. 11, which will be described later.

Next, in Step S302, the relationship information registration part 1001 makes a determination on a value of an identifier indicating start or end of the containment relationship in the relationship information piece. If the identifier is a value indicating the start (S302: start), the relationship information registration part 1001 proceeds to registration of root information end in the lower layer tree (S303). On the other hand, if the identifier is a value indicating end (5302: end), the relationship information registration part 1001 proceeds to registration of root information end in the upper layer tree (S305).

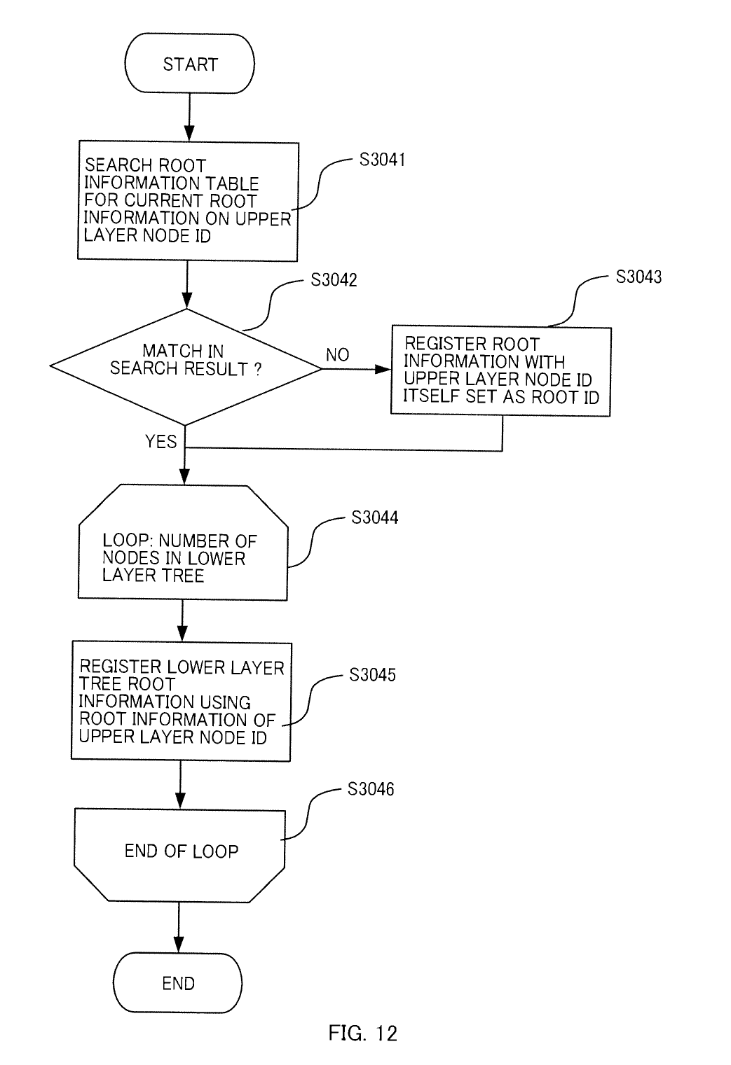

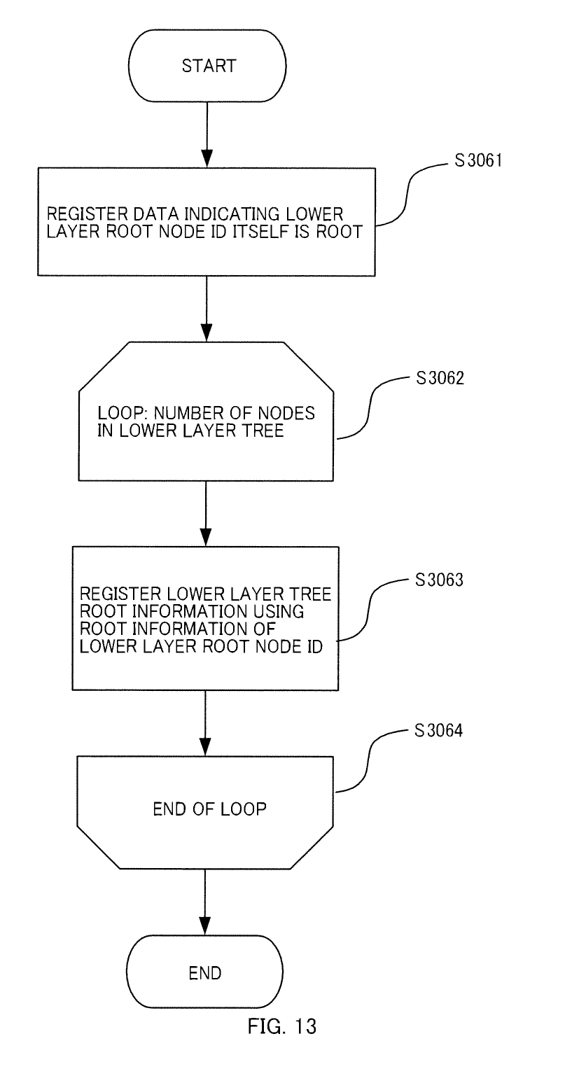

In Step S303, the relationship information registration part 1001 performs a search on the root information table 1011 to find one or more records in which the root ID 1011b therein is equal to the received lower layer root node ID and the end date and time 1011f is null. For each of those records, the relationship information registration part 1001 sets the date and time information obtained in Step S100 into a corresponding field as the end date and time 1011f. This setting shows that the lower layer root node ID is no longer a root ID of the tree. Note that the detail of Step S304 which is the next step is shown in FIG. 12, which will described later. In Step S305, the relationship information registration part 1001 performs a search on the root information table 1011 to find one or more records which satisfy the following conditions: the root ID 1011b is equal to the root ID of the received upper layer node ID; the end date and time 1011f is null; and the node is subordinate to the lower layer root node ID (dependent identifier). Then, the relationship information registration part 1001 sets the date and time information piece obtained in Step S100 in corresponding fields as the end date and time 1011f of the found records. This setting shows that the object no longer belongs to the upper layer tree. The “node subordinate to the lower layer root node ID” is a node which satisfies the following conditions: the root ID 1011b is equal to the lower layer root node ID; the left-end value 1011c is larger than the left-end value of the lower layer root node ID; and the right-end value 1011d is smaller than the right-end value of the lower layer root node ID. A process flow of Step S306 which is the next process is shown in FIG. 13, which will be described later.

### Process Flow Example 3

Next, a description is given of the sensor ID replacement process (S301) mentioned in Process Flow Example 2 above. FIG. 11 shows the process flow of the sensor ID replacement process S301. In this case, the relationship information registration part 1001 iterates the process from Steps S3012 to S3015 (while performing Steps S3011 to S3015) for the lower layer root node ID and the upper layer node ID obtained in Step S100 above. In Step S3012, the relationship information registration part 1001 performs a search on the relationship information table 1010 to find if a sensor 400 is installed on an object having the node ID in the loop. For example, in the case of the relationship information table 1010 shown in FIG. 6, the relationship information registration part 1001 searches for a record satisfying conditions that: the lower layer root node ID 1010a is equal to the node ID in the loop; the end date and time 1010d is null; and the relationship type 1010e is “sensor installation” indicating that a sensor is installed.

Then, in Step S3013, the relationship information registration part 1001 determines whether or not there is a match in the search result in Step S3012. If there is a match (S3013: YES), the relationship information registration part 1001 proceeds to Step S3014. On the other hand, if there is no match (S3013: NO), the relationship information registration part 1001 returns to the beginning of the loop (S3015 to S3011).

In Step S3014, the relationship information registration part 1001 replaces the node ID in the loop with the value of the upper layer node ID 1010b in the record obtained as the search result.

### Process Flow Example 4

Next, a description is given of Step S304 described in Process Flow Example 2 above. FIG. 12 shows a process flow of Step S304. In this case, in Step S3041, the relationship information registration part 1001 performs a search on the root information table 1011 for current root information related to the upper layer node ID. For example, in the case of the root information table 1011 shown in FIG. 7, the relationship information registration part 1001 searches for a record satisfying conditions that: the lower layer root node ID 1010a is equal to the upper layer node ID; and the end date and time 1011f is null.

Then, in Step S3042, the relationship information registration part 1001 determines whether or not there is a match in the search result in Step S3041. If there is no match (S3042: NO) in Step S3041, the relationship information registration part 1001 proceeds to Step S3043. On the other hand, if there is a match (S3042: YES) in Step S3041, the relationship information registration part 1001 proceeds to Step S3044.

In Step S3043, the relationship information registration part 1001 registers a root information piece with the upper layer node ID itself set as a root ID thereof. For example, in the case of data shown in FIG. 7, the relationship information registration part 1001 sets: the upper layer node ID as the node ID 1011a and the root ID 1011b; as the left-end value 1011c, for example, 0 which is an initial value set in advance; as the right-end value 1011d, for example, 10 which is an initial value set in advance; and as the start date and time 1011e, the date and time information piece obtained in Step S100. Values other than the above may be set as the initial values of the left-end and right-end values. However, the right-end value must be larger than the left-end value.

In Step S3044, the relationship information registration part 1001 iterates the process from Step S3045 to Step S3046 as many times as the number of nodes in the lower layer tree. The nodes in the lower layer tree are nodes processed in Step S303.

In Step S3045, the relationship information registration part 1001 registers apiece of root information on the lower layer tree into the root information table 1011 using a piece of the previous root information on the lower layer root node ID processed in Step S303, the node ID included in the lower layer tree, and a piece of root information searched for in Step S3041 on the upper layer node ID or the piece of information on the upper layer node ID registered in S3043. For example, in the case of data pieces shown in FIG. 7, the relationship information registration part 1001 sets: a corresponding one of the node IDs in the lower layer tree as the node ID 1011a; as the root ID 1011b, the root ID corresponding to the upper layer node ID; and as the start date and time 1011e, the date and time information piece obtained in Step S100. In addition, as the left-end value 1011c, the relationship information registration part 1001 sets a value calculated using an expression shown below (Equation 1).

(left-end value of previous root information of process target node−left-end value of lower layer root node ID)×reduction ratio+second right-end value of upper layer node ID (Equation 1)

A value calculated using an expression shown below (Equation 2) is set as the right-end value 1011d.

(right-end value of previous root information of process target node−left-end value of lower layer root node ID)×reduction ratio+second right-end value of upper layer node ID (Equation 2)

The “reduction ratio” in Equations 1 and 2 is a ratio to reduce the lower layer root node ID size to a size within a node size of the upper layer node ID. A value satisfying an expression shown below (Equation 3) is set as the “reduction ratio.”

Reduction ratio<(right-end value of upper layer node−left-end value of upper layer node)/(right-end value of lower layer root node−left-end value of lower layer root node) (Equation 3)

The second right-end value of the upper layer node ID in (Equation 1) and (Equation 2) represents the maximum value of the right-end value of a node directly below the upper layer node and is obtained in the following manner. Specifically, a search is performed on the root information table 1011 to find a record which satisfies that: the root ID 1011b is equal to the upper layer node ID; the left-end value 1011c is larger than the left-end value of the upper layer node ID; and the right-end value 1011d is smaller than the right-end value of the upper layer node ID. Then, a value whose left-end value 1011c is the largest in the search results is used as the second right-end value of the upper layer node ID. The relationship information registration part 1001 iterates the process in Step S3045 described above as many times as the number of nodes in the lower layer tree.

### Process Flow Example 5

Next, a description is given of the processing in Step S306 described in Process Flow Example 2 described above. FIG. 13 shows a process flow of Step S306. In this case, in Step S3061, the relationship information registration part 1001 registers root information piece indicating that the lower layer root node ID is the root ID of the lower layer tree thereof into the root information table 1011. For example, in the case of data pieces in FIG. 7, the relationship information registration part 1001 sets the lower layer root node ID as the node ID 1011a and the root ID 1011b; sets 0, which is an initial value set in advance, as the left-end value 1011c; sets 10, which is an initial value set in advance, as the right-end value 1011d; and sets the date and time information piece obtained in Step S100 as the start date and time 1011e.

Subsequently, in Step S3062, the relationship information registration part 1001 iterates processing from Step S3063 to Step S3064 as many times as the number of nodes in the lower layer tree. Note that the lower layer root node ID which is the root ID of the lower layer tree is excluded. In addition, the nodes in the lower layer tree are node processed in Step S305.

In Step S3063, the relationship information registration part 1001 registers apiece of root information on the lower layer tree into the root information table 1011 using the node ID included in the lower layer tree and a piece of the root information on the lower layer root node ID registered in Step S3061. For example, in the case of data pieces shown in FIG. 7, the relationship information registration part 1001 sets: a corresponding one of the nodes ID in the lower layer tree as the node ID 1011a; the lower layer root node ID as the root ID 1011b; and the date and time information piece obtained in Step S100 as the start date and time 1011e.

A value calculated by an expression shown below (Equation 4) is set as the left-end value 1011c.

(left-end value of previous root information of process target node−left-end value of previous root information of lower layer root node ID)×enlargement ratio (Equation 4)

A value calculated by an expression shown below (Equation 5) is set as the right-end value 1011d.

(right-end value of previous root information of process target node−left-end value of previous root information of lower layer root node ID)×enlargement ratio (Equation 5)

The “enlargement ratio” in Equations 4 and 5 is a ratio to enlarge (restore) the node size of the lower layer root node ID to the node size of the initial values. A value satisfying an expression shown below (Equation 6) is set as the “enlargement ratio.”

(initial right-end value−initial left-end value)/(right-end value of previous root information of lower layer root node−left-end value thereof) (Equation 6)

The relationship information registration part 1001 iterates the process in Step S3063 as many times as the number of the nodes in the lower layer tree. The processing described above prevents the reduction ratio of nodes to be newly added to a lower layer tree from being extremely small and the number of the significant digits of a computing device which executes the processing from overflowing.

### Process Flow Example 6

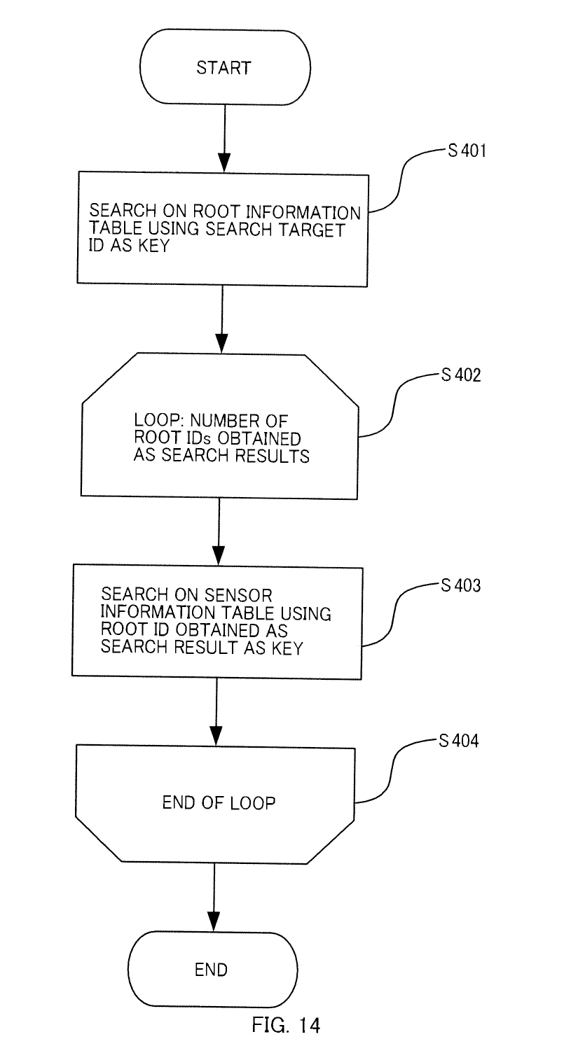

Next, a description is given of processing executed by the sensor information searching part 1002. FIG. 14 shows a process flow of the sensor information searching part 1002. In this case, the sensor information searching part 1002 receives, as a sensor information reference request, an ID of an object to be searched for, a start and end date and times indicating a time period to be searched for, from the IO control unit 104 or the external terminal via the communication unit 105, obtains an identifier located at the highest layer in the relationship for the transport object or the transportation unit from the root information table 1011, obtains a sensor information piece in the sensor information table 1012 using the obtained identifier as a key, and then outputs the sensor information piece as a sensor information piece of the transport object or the transportation unit to the IO control unit 104 or the external terminal via the communication unit 105.

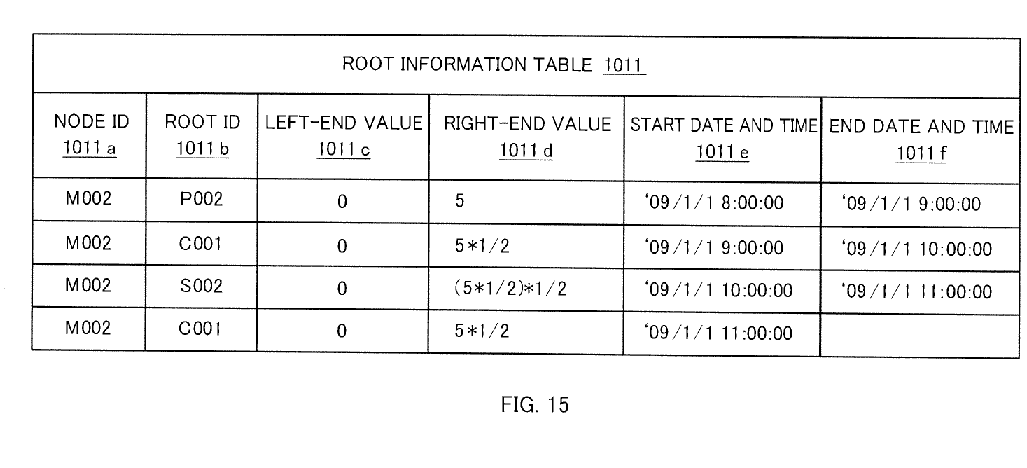

The sensor information searching part 1002 searches the root information table 1011 to find one or more records satisfying that: the node ID 1011a is equal to the ID of an object to be searched for which is received in the reference request; the start date and time 1010c is before the end date and time received in the reference request; and the end date and time 1010d is after the start date and time received in the reference request (S401). FIG. 15 shows search results obtained by performing a search on the root information table 1011, for example, in a case of data shown in FIG. 7, with a product “M002” being used as an ID of an object to be searched for and the start and end dates and times being an entire range.

The sensor information searching part 1002 iterates the process from Step S403 to Step S404 as many times as the number of root IDs 1011b obtained as the search results in Step S401 (S402). In this case, the sensor information searching part 1002 performs a search on the sensor information table 1012 to find one or more records satisfying that: the sensor device ID 1012a is equal to the root ID 1011b shown by a corresponding one of the search results (in Step S401); the date and time 1012b is after the start date and time 1011e and before the end date and time 1011f of the search result (S403).

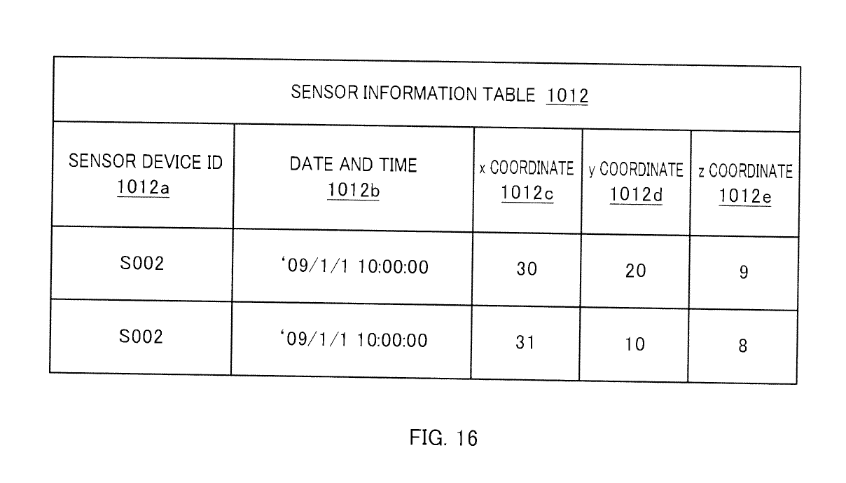

The sensor information searching part 1002 iterates the processing in Step S403 above as many times as the number of the search results obtained in Step S401. For example, in the case where the processing results in Step S401 are data shown in FIG. 15, after the sensor information table 1012 is searched for the root IDs 1011b, sensor information shown in FIG. 16 is obtained. Even though a sensor is not directly installed on each of the objects, it is possible to obtain sensor information.

### Second Embodiment

In First Embodiment described above, in such process as shown in Steps S3043 and S3061 in which the node ID itself is set as the root ID 1011b, and thereby a root information piece is registered, values to be set as the left-end value 1011c and the right-end value 1011d are set in advance. In contrast, in Second Embodiment, a description is given of a mode in which the values to be set as the left-end value 1011c and the right-end value 1011d can be set according to the type of the node ID.

A configuration example of a sensor information management system in Second Embodiment is the same as the configuration example of the sensor information management system in First Embodiment shown in FIG. 1, but is different in contents of some data held in the storage unit 101 of the sensor information server 100.

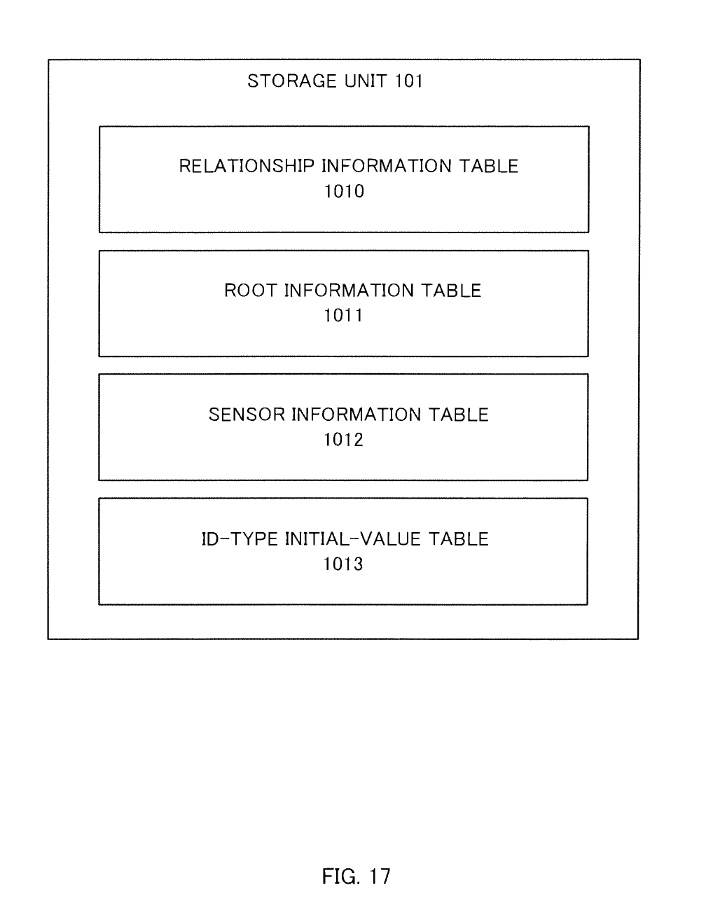

FIG. 17 shows data pieces held by the storage unit 101 in the sensor information server 100 in Second Embodiment. The storage unit 101 holds an ID-type initial-value table 1013 in addition to the relationship information table 1010, the root information table 1011, and the sensor information table 1012 in this case. The relationship information table 1010, the root information table 1011, and the sensor information table 1012 have the same structures as those respective tables in First Embodiment.

In contrast, the ID-type initial-value table 1013 is a table which holds ID types of the transport objects 600, the transportation units 500, and the sensors 400, and initial values as a right-end value and a left-end value of a corresponding one of ID types. The ID type can be set in the following manner. For example, when a tree structure formed by the transport object 600, the transportation unit 500 and the sensor 400 can be expressed as “product—pallet—container—transportation aircraft” from a lower layer node to an upper layer node in a basic tree structure, the ID type can be set as a “product,” a “pallet,” a “container,” and a “transportation aircraft.” The right-end value may be set freely. In contrast, the initial value of the left-end value is set in such a manner that an ID type set in a higher layer, for example, in the ID types set above has a larger difference between the left-end value and the right-end value. The initial values held in the ID-type initial-value table 1013 are used to set the node ID itself as the root ID 1011b in the new registration of root information end in lower layer tree (using a root of the upper layer tree) shown in FIG. 12 and the new registration of root information end in lower layer tree (using a root of the lower layer tree) shown in FIG. 13 to perform the processing of registering a root information piece.

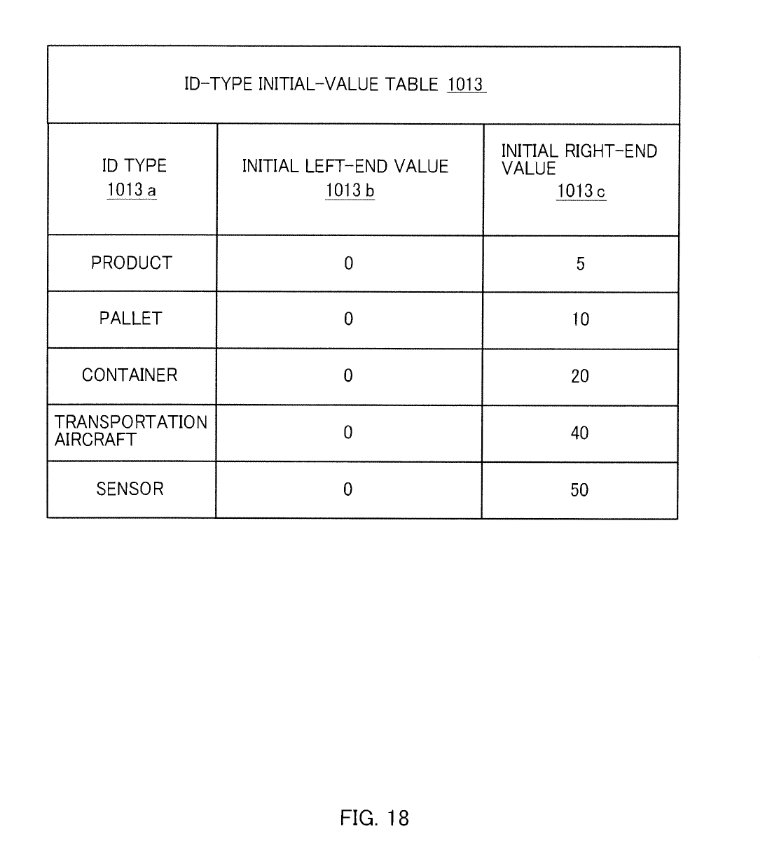

FIG. 18 shows a configuration example of the 1D-type initial-value table 1013. The ID-type initial-value table 1013 is a set of records including an ID type 1013a, an initial left-end value 1013b, and an initial right-end value 1013c. An identifier indicating the type of a node ID is set as the ID type 1013a. An initial value to be set for the left-end value 1011c is set as the initial left-end value 1013b. An initial value to be set for the right-end value 1011d is set as the initial right-end value 1013c.

Hereinbelow, with the ID-type initial-value table 1013, a description is given of the “new registration of root information end in lower layer tree (using a root of the upper layer tree)” (FIG. 12) and the “new registration of root information end in lower layer tree (using a root of the lower layer tree) (FIG. 13), focused on differences from First Embodiment.

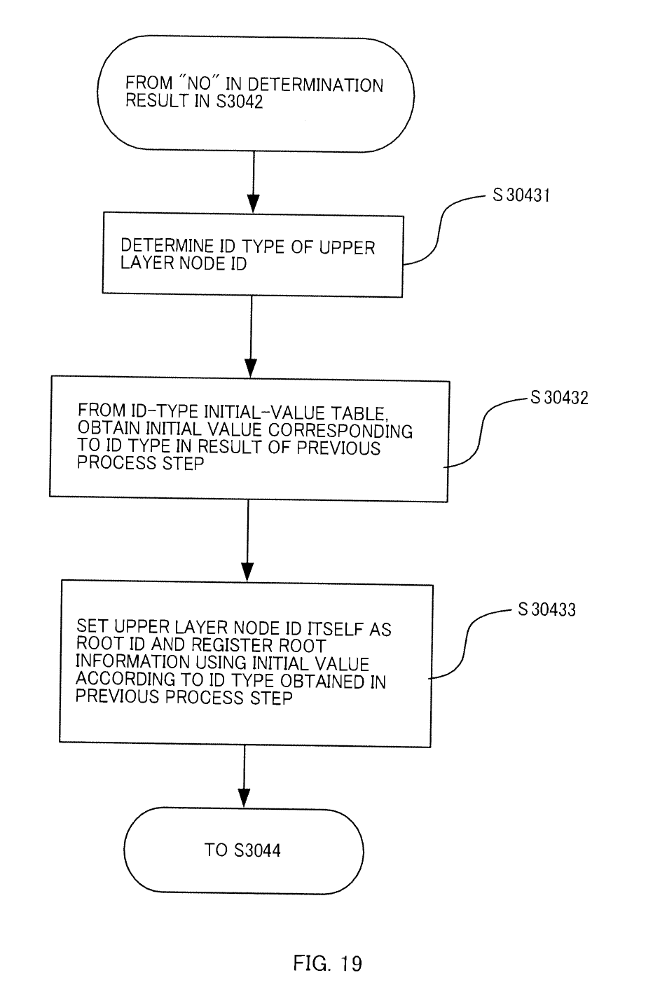

Firstly, the same process as up to Step S3042 described in First Embodiment referring to FIG. 12 is performed on the new registration of root information end in lower layer tree (using a root of the upper layer tree)” in Second Embodiment. However, the process to be performed if the determination result in Step S3042 is “NO” is different in Second Embodiment. FIG. 19 shows the processing to be performed if the determination result in Step S3042 is “NO.”

If the determination result in Step S3042 is “NO,” the relationship information registration part 1001 determines the ID type of the upper layer node ID in Step S30431. The determination of the ID type is made based on an ID scheme determined in advance. For example, an ID having an ID type of “product” is prefixed with “P.” Alternatively, master information respectively indicating ID types of all IDs used in the sensor information management system are held. Thereby, the determination may be made by referring to a corresponding one of the master information.

Subsequently, in Step S30432, the relationship information registration part 1001 obtains from the ID-type initial-value table 1013 initial values corresponding to the ID type obtained by the determination process in Step S30431. In Step S30433, the relationship information registration part 1001 sets the upper layer node ID itself as a root ID thereof, registers a root information piece using the initial values corresponding to the ID type obtained in the previous process, and proceeds to Step S3044. The process after Step S3044 is the same as the process shown in First Embodiment.

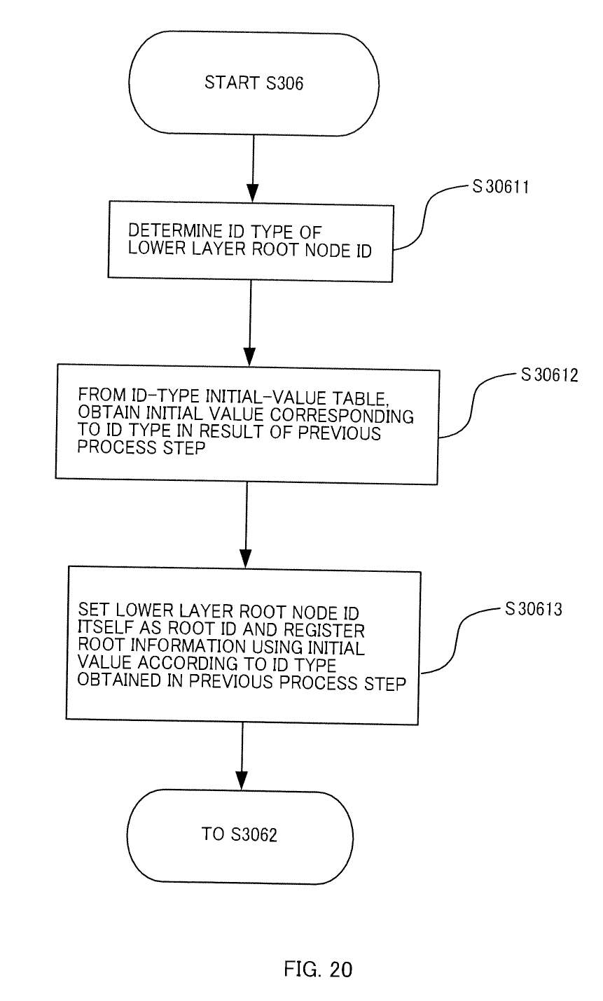

Next, a description is given of the “new registration of root information end in lower layer tree (using a root of the lower layer tree) in Second Embodiment. Note that process up to Step S3062 described based on FIG. 13 is different between First embodiment and Second Embodiment. FIG. 20 shows process up to Step S3062 in Second Embodiment.

In this case, the relationship information registration part 1001 determines the ID type of the lower layer root node ID in Step S30611. The ID type determination is made based on a system determined in advance for used IDs. For example, an ID having an ID type of “product” is prefixed with “P.” Alternatively, master information pieces respectively indicating ID types of all IDs used in the sensor information management system are held. Thereby, the determination may be made by referring to a corresponding one of the master information pieces.

Subsequently, in Step S30612, the relationship information registration part 1001 obtains from the ID-type initial-value table 1013 initial values corresponding to the ID type obtained by the determination processing. In Step S30613, the relationship information registration part 1001 sets the lower layer node ID itself as a root ID thereof, registers a root information piece by using the initial values corresponding to the ID type obtained in the previous processing, and proceeds to Step S3062. The processing after Step S3062 is the same as the processing shown in First Embodiment.

As described above, the initial right-end and left-end values of the node can be set for each of the ID types, and thereby initial values according to the number of objects actually containable in the transport object 600 or transportation unit 500 assigned an ID can be set. When a large volume of objects are loaded on the transport object 600 or transportation unit 500, this prevents the right-end and left-end values calculated by the relationship information registration part 1001 from becoming upper layer node unnecessarily small and the number of the significant digits of a computing device which executes the process from overflowing.

Heretofore, the best modes for carrying out the present invention have been specifically described. However, the present invention is not limited thereto, and various modifications can be made without departing from the spirit thereof. For example, the description has been given of the example of using a positioning sensor in the aforementioned embodiments, but an acceleration sensor or the like may be used as the sensor.

In addition, the description has been given by taking the transportation and management work of products as the example in the aforementioned embodiments. However, the present invention is applicable to any work for which information on product movement and a relationship between a product and a transportation unit can be collected, for example, manufacturing and processing work and retail sales work.

Moreover, any tag may be used as a tag used in the aforementioned embodiments, as long as it is a data carrier which holds a unique ID for identifying an object, such as an RFID tag, a barcode tag or a two-dimensional code tag.

The description has been given in the aforementioned embodiments on the assumption that the server (sensor information server) collectively manages the relationship information pieces, the root information pieces and the like. However, even in a case where information pieces and functions are distributed to be held or the like, the information pieces and the functions may actually be held in any place, as long as they can be freely used and referred to, for example, by virtually and collectively managed by the server.

The embodiments described above makes it possible to manage various containment relationships such as packing relationships and loading relationships of an article, and to efficiently search for sensor information measured by a sensor related to the article thereby to provide the information to the user.

At least the following is made clear throughout the description of the specification. Specifically, in the sensor information management system, the relationship information table in the storage unit may be configured to hold the relationship information on one of the packing and loading relationship and the installation relationship between the transport object, the transportation unit capable of packing, loading and transporting the transport object, and the sensor installed on the transport object or the transportation unit, the relationship information including the information on the hierarchy of the identifiers associated with the respective objects establishing the relationship and relationship type information indicating a content of the each of the relationships.

In this case, it is more preferable if the relationship information registration part performs a search on the relationship information table for the lower layer identifier and the upper layer identifier included in the relationship information to be registered, determines whether or not any of the lower layer identifier and the upper layer identifier has an installation relationship with the sensor on the basis of the relationship type information obtained by the search, and, for the identifier which has been determined as being installed with the sensor, performs a registration process into the relationship information table with the relationship information in which the identifier is replaced with an identifier of the sensor.

Moreover, in the sensor information management system, the relationship information table in the storage unit may be configured to hold the relationship information on one of the packing and loading relationship and the installation relationship between the transport object, the transportation unit capable of packing, loading or transporting the transport object, and the sensor installed on one of the transport object and the transportation unit, the relationship information including the information on the hierarchy of the identifiers associated with the respective objects establishing the relationship, the relationship type information indicating a content of the each of the relationships, and relationship period information indicating a time period during which the relationship is maintained.

In addition, it is preferable if the root information table in the storage unit is configured to hold root information on the each upper layer and lower layer identifier pair establishing one of the packing and loading relationship and the installation relationship, the identifier at the highest layer in one of the packing and loading relationship and the installation relationship being taken as the upper layer identifier and set as the root information, the root information table including the relationship period information indicating the period during which the relationship is maintained.

In this case, it is even more preferable if the relationship information registration part is configured to receive the relationship information on one of the packing and loading relationship and the installation relationship in which the change has occurred, and in a case where the relationship type information in the relationship information indicates attachment, such as packing, loading or containment, of an object having the lower layer identifier to an object having the upper layer identifier, perform a search on the relationship information table using the lower layer identifier as a key to specify a dependent identifier having the lower layer identifier as an upper layer identifier thereof, update, for the lower layer identifier and the dependent identifier, a relationship end date and time indicated by the relationship period information in the root information table with a date and time of the attachment indicated by the relationship information, perform a search on the root information table using the upper layer identifier as a key to specify corresponding root information, and register the thus specified root information into the root information table as the root information for the lower layer identifier and the dependent identifier.

In addition, in the sensor information management system, the relationship information table in the storage unit may be configured to hold the relationship information on one of the packing and loading relationship and the installation relationship between the transport object, the transportation unit capable of packing, loading or transporting the transport object, and the sensor installed on one of the transport object and the transportation unit, the relationship information including the information on the hierarchy of the identifiers associated with the respective objects establishing the relationship, the relationship type information indicating a content of the each of the relationships, and relationship period information indicating a time period during which the relationship is maintained.

In addition, the root information table in the storage unit may be configured to hold root information on the each upper layer and lower layer identifier pair establishing one of the packing and loading relationship and the installation relationship, the identifier at the highest layer in one of the packing and loading relationship and the installation relationship being taken as the upper layer identifier and set as the root information, the root information table including the relationship period information indicating the period during which the relationship is maintained.

In this case, it is more preferable if the relationship information registration part is configured to receive the relationship information on one of the packing and loading relationship and the installation relationship in which the change has occurred, and in a case where the relationship type information in the relationship information indicates detachment, such as unpacking and unloading, of an object having the lower layer identifier from an object having the upper layer identifier, perform a search on the relationship information table using the lower layer identifier as a key to specify a dependent identifier having the lower layer identifier as an upper layer identifier thereof, update, for the lower layer identifier and the dependent identifier, a relationship end date and time indicated by the relationship period information in the root information table with a date and time of the detachment indicated by the relationship information, perform a search on the root information table using the lower layer identifier as a key to specify corresponding root information, and register the thus specified root information into the root information table as the root information for the lower layer identifier and the dependent identifier.

In the sensor information management system, the storage unit may store an ID-type initial-value table configured to hold identifier types, such as a product, pallet, and container, corresponding to the identifiers, and initial values which are values indicating a containment relationship for each of the identifier types of identifiers.

In this case, it is preferable if the relationship information registration part is configured to perform, upon registration of the relationship information, a process of determining the identifier type and the initial value of each of the upper layer identifier and the lower layer identifier indicated by the relationship information using the ID-type initial-value table, in a case where relationship type information in the relationship information indicates attachment, such as packing, loading or containment, of the object having the lower layer identifier to the object having the upper layer identifier, reducing a range defined by the initial value of the lower layer identifier to a range small enough to be included in a range defined by the initial value of the upper layer identifier and then setting a reduction value thus obtained in association with the lower layer identifier in the root information table, and in a case where the relationship type information in the relationship information indicates detachment, such as unpacking of or unloading, of the object having the lower layer identifier from the object having the upper layer identifier, restores the reduction value set for the lower layer identifier in the root information table to the initial value of the lower layer identifier.

What is claimed is:

1. A sensor information management system which is a computer system for managing sensor information measured by a sensor, the sensor information management system comprising:
a storage unit in which a relationship information table, a root information table and a sensor information table are stored,
the relationship information table being configured to hold relationship information on one of packing and loading relationship and an installation relationship between a transport object, a transportation unit capable of packing, loading or transporting the transport object, and a sensor installed on one of the transport object and the transportation unit, the relationship information including information on a hierarchy of identifiers associated with respective objects establishing the relationship,
the root information table being configured to hold root information on each upper layer and lower layer identifier pair establishing one of the packing and loading relationship and the installation relationship, an identifier at the highest layer in one of the packing and loading relationship and the installation relationship being taken as the upper layer identifier and set as the root information, and
the sensor information table being configured to hold an identifier of the sensor and a history of sensor information measured by the sensor associated with the identifier;
a relationship information registration part configured to receive, upon occurrence of a change in one of the packing and loading relationship and the installation relationship, the relationship information on one of the packing and loading relationship and the installation relationship in which the change has occurred, from one of an input unit and an external terminal via a communication unit, register the relationship information into the relationship information table, perform a search on the root information table using a key the lower layer identifier in the pair of identifiers indicated by the received relationship information a key, specify a dependant identifier having the lower layer identifier as an upper layer identifier thereof, specify corresponding root information by performing a search on the root information table using the upper layer identifier in the pair of identifiers as a key, and register the specified root information into the root information table as root information of the dependent identifier; and
a sensor information searching part configured to receive a reference request for sensor information corresponding to one of a certain transport object and a certain transportation unit, the reference request being received from one of the input unit and the external terminal via the communication unit, obtain an identifier located at the highest layer among identifiers related with the transport object or the transportation unit, the identifier being obtained from the root information table, obtain the sensor information from the sensor information table with the obtained identifier being a key, and output the sensor information as the sensor information on one of the transport object and the transportation unit to one of an output unit or the external terminal via the communication unit.

2. The sensor information management system according to claim 1, wherein
the relationship information table in the storage unit is configured to hold the relationship information on one of the packing and loading relationship and the installation relationship between the transport object, the transportation unit capable of packing, loading and transporting the transport object, and the sensor installed on the transport object or the transportation unit, the relationship information including the information on the hierarchy of the identifiers associated with the respective objects establishing the relationship and relationship type information indicating a content of the each of the relationships, and
the relationship information registration part performs a search on the relationship information table for the lower layer identifier and the upper layer identifier included in the relationship information to be registered, determines whether or not any of the lower layer identifier and the upper layer identifier has an installation relationship with the sensor on the basis of the relationship type information obtained by the search, and, for the identifier which has been determined as being installed with the sensor, performs a registration process into the relationship information table with the relationship information in which the identifier is replaced with an identifier of the sensor.

3. The sensor information management system according to claim 1, wherein
the relationship information table in the storage unit is configured to hold the relationship information on one of the packing and loading relationship and the installation relationship between the transport object, the transportation unit capable of packing, loading or transporting the transport object, and the sensor installed on one of the transport object and the transportation unit, the relationship information including the information on the hierarchy of the identifiers associated with the respective objects establishing the relationship, the relationship type information indicating a content of the each of the relationships, and relationship period information indicating a time period during which the relationship is maintained,
and wherein the root information table in the storage unit is configured to hold root information on the each upper layer and lower layer identifier pair establishing one of the packing and loading relationship and the installation relationship, the identifier at the highest layer in one of the packing and loading relationship and the installation relationship being taken as the upper layer identifier and set as the root information, the root information table including the relationship period information indicating the period during which the relationship is maintained,
the relationship information registration part being configured to
receive the relationship information on one of the packing and loading relationship and the installation relationship in which the change has occurred, and
in a case where the relationship type information in the relationship information indicates attachment, such as packing, loading or containment, of an object having the lower layer identifier to an object having the upper layer identifier,
perform a search on the relationship information table using the lower layer identifier as a key to specify a dependent identifier having the lower layer identifier as an upper layer identifier thereof,
update, for the lower layer identifier and the dependent identifier, a relationship end date and time indicated by the relationship period information in the root information table with a date and time of the attachment indicated by the relationship information,
perform a search on the root information table using the upper layer identifier as a key to specify corresponding root information, and
register the thus specified root information into the root information table as the root information for the lower layer identifier and the dependent identifier.

4. The sensor information management system according to claim 1, wherein
the relationship information table in the storage unit is configured to hold the relationship information on one of the packing and loading relationship and the installation relationship between the transport object, the transportation unit capable of packing, loading or transporting the transport object, and the sensor installed on one of the transport object and the transportation unit, the relationship information including the information on the hierarchy of the identifiers associated with the respective objects establishing the relationship, the relationship type information indicating a content of the each of the relationships, and relationship period information indicating a time period during which the relationship is maintained,
and wherein the root information table in the storage unit is configured to hold root information on the each upper layer and lower layer identifier pair establishing one of the packing and loading relationship and the installation relationship, the identifier at the highest layer in one of the packing and loading relationship and the installation relationship being taken as the upper layer identifier and set as the root information, the root information table including the relationship period information indicating the period during which the relationship is maintained,
the relationship information registration part being configured to
receive the relationship information on one of the packing and loading relationship and the installation relationship in which the change has occurred, and
in a case where the relationship type information in the relationship information indicates detachment, such as unpacking and unloading, of an object having the lower layer identifier from an object having the upper layer identifier,
perform a search on the relationship information table using the lower layer identifier as a key to specify a dependent identifier having the lower layer identifier as an upper layer identifier thereof,
update, for the lower layer identifier and the dependent identifier, a relationship end date and time indicated by the relationship period information in the root information table with a date and time of the detachment indicated by the relationship information,
perform a search on the root information table using the lower layer identifier as a key to specify corresponding root information, and
register the thus specified root information into the root information table as the root information for the lower layer identifier and the dependent identifier.

5. The sensor information management system according to claim 1, wherein
the storage unit stores an ID-type initial-value table configured to hold identifier types, such as a product, pallet, and container, corresponding to the identifiers, and initial values which are values indicating a containment relationship for each of the identifier types of identifiers,
and wherein the relationship information registration part is configured to perform, upon registration of the relationship information, a process of
determining the identifier type and the initial value of each of the upper layer identifier and the lower layer identifier indicated by the relationship information using the ID-type initial-value table,
in a case where relationship type information in the relationship information indicates attachment, such as packing, loading or containment, of the object having the lower layer identifier to the object having the upper layer identifier, reducing a range defined by the initial value of the lower layer identifier to a range small enough to be included in a range defined by the initial value of the upper layer identifier and then setting a reduction value thus obtained in association with the lower layer identifier in the root information table, and
in a case where the relationship type information in the relationship information indicates detachment, such as unpacking of or unloading, of the object having the lower layer identifier from the object having the upper layer identifier, restores the reduction value set for the lower layer identifier in the root information table to the initial value of the lower layer identifier.

6. A sensor information management method for managing sensor information measured by a sensor, the sensor information management method being performed by a computer system provided with a storage unit in which a relationship information table, a root information table and a sensor information table are stored,
the relationship information table being configured to hold relationship information on one of packing and loading relationship and an installation relationship between a transport object, a transportation unit capable of packing, loading or transporting the transport object, and a sensor installed on one of the transport object and the transportation unit, the relationship information including information on a hierarchy of identifiers associated with respective objects establishing the relationship,
the root information table being configured to hold root information on each upper layer and lower layer identifier pair establishing one of the packing and loading relationship and the installation relationship, an identifier at the highest layer in one of the packing and loading relationship and the installation relationship being taken as the upper layer identifier and set as the root information, and
the sensor information table being configured to hold an identifier of the sensor and a history of sensor information measured by the sensor associated with the identifier,
the sensor information management method comprising:
performing a process of receiving, upon occurrence of a change in one of the packing and loading relationship and the installation relationship, the relationship information on one of the packing and loading relationship and the installation relationship in which the change has occurred, from one of an input unit and an external terminal via a communication unit, registering the relationship information into the relationship information table, performing a search on the root information table using a key the lower layer identifier in the pair of identifiers indicated by the received relationship information a key, specifying a dependant identifier having the lower layer identifier as an upper layer identifier thereof, specifying corresponding root information by performing a search on the root information table using the upper layer identifier in the pair of identifiers as a key, and registering the specified root information into the root information table as root information of the dependent identifier; and
performing a process of receiving a reference request for sensor information corresponding to one of a certain transport object and a certain transportation unit, the reference request being received from one of the input unit and the external terminal via the communication unit, obtaining an identifier located at the highest layer among identifiers related with the transport object or the transportation unit, the identifier being obtained from the root information table, obtaining the sensor information from the sensor information table with the obtained identifier being a key, and outputting the sensor information as the sensor information on one of the transport object and the transportation unit to one of an output unit or the external terminal via the communication unit.

7. The sensor information management method according to claim 6, wherein
the relationship information table is configured to hold the relationship information on one of the packing and loading relationship and the installation relationship between the transport object, the transportation unit capable of packing, loading and transporting the transport object, and the sensor installed on the transport object or the transportation unit, the relationship information including the information on the hierarchy of the identifiers associated with the respective objects establishing the relationship and relationship type information indicating a content of the each of the relationships, and
the process of registering into the root information table includes performing a search on the relationship information table for the lower layer identifier and the upper layer identifier included in the relationship information to be registered, determining whether or not any of the lower layer identifier and the upper layer identifier has an installation relationship with the sensor on the basis of the relationship type information obtained by the search, and, for the identifier which has been determined as being installed with the sensor, performing a registration process into the relationship information table with the relationship information in which the identifier is replaced with an identifier of the sensor.

8. The sensor information management method according to claim 6, wherein
the relationship information table is configured to hold the relationship information on one of the packing and loading relationship and the installation relationship between the transport object, the transportation unit capable of packing, loading or transporting the transport object, and the sensor installed on one of the transport object and the transportation unit, the relationship information including the information on the hierarchy of the identifiers associated with the respective objects establishing the relationship, the relationship type information indicating a content of the each of the relationships, and relationship period information indicating a time period during which the relationship is maintained,
and wherein the root information table is configured to hold root information on the each upper layer and lower layer identifier pair establishing one of the packing and loading relationship and the installation relationship, the identifier at the highest layer in one of the packing and loading relationship and the installation relationship being taken as the upper layer identifier and set as the root information, the root information table including the relationship period information indicating the period during which the relationship is maintained,
the process of registration into the root information table includes receiving the relationship information on one of the packing and loading relationship and the installation relationship in which the change has occurred, and
in a case where the relationship type information in the relationship information indicates attachment, such as packing, loading or containment, of an object having the lower layer identifier to an object having the upper layer identifier,
performing a search on the relationship information table using the lower layer identifier as a key to specify a dependent identifier having the lower layer identifier as an upper layer identifier thereof,
updating, for the lower layer identifier and the dependent identifier, a relationship end date and time indicated by the relationship period information in the root information table with a date and time of the attachment indicated by the relationship information,
performing a search on the root information table using the upper layer identifier as a key to specify corresponding root information, and
registering the thus specified root information into the root information table as the root information for the lower layer identifier and the dependent identifier.

9. The sensor information management method according to claim 6, wherein
the relationship information table is configured to hold the relationship information on one of the packing and loading relationship and the installation relationship between the transport object, the transportation unit capable of packing, loading or transporting the transport object, and the sensor installed on one of the transport object and the transportation unit, the relationship information including the information on the hierarchy of the identifiers associated with the respective objects establishing the relationship, the relationship type information indicating a content of the each of the relationships, and relationship period information indicating a time period during which the relationship is maintained,
and wherein the root information table is configured to hold root information on the each upper layer and lower layer identifier pair establishing one of the packing and loading relationship and the installation relationship, the identifier at the highest layer in one of the packing and loading relationship and the installation relationship being taken as the upper layer identifier and set as the root information, the root information table including the relationship period information indicating the period during which the relationship is maintained,
the process of registration into the root information table includes
receiving the relationship information on one of the packing and loading relationship and the installation relationship in which the change has occurred, and
in a case where the relationship type information in the relationship information indicates detachment, such as unpacking and unloading, of an object having the lower layer identifier from an object having the upper layer identifier,
performing a search on the relationship information table using the lower layer identifier as a key to specify a dependent identifier having the lower layer identifier as an upper layer identifier thereof,
updating, for the lower layer identifier and the dependent identifier, a relationship end date and time indicated by the relationship period information in the root information table with a date and time of the detachment indicated by the relationship information,
performing a search on the root information table using the lower layer identifier as a key to specify corresponding root information, and
registering the thus specified root information into the root information table as the root information for the lower layer identifier and the dependent identifier.

10. The sensor information management method according to claim 6, wherein
the storage unit stores an ID-type initial-value table configured to hold identifier types, such as a product, pallet, and container, corresponding to the identifiers, and initial values which are values indicating a containment relationship for each of the identifier types of identifiers,
and wherein the process of registration into the root information table includes performing, upon registration of the relationship information, a process of
determining the identifier type and the initial value of each of the upper layer identifier and the lower layer identifier indicated by the relationship information using the ID-type initial-value table,
in a case where relationship type information in the relationship information indicates attachment, such as packing, loading or containment, of the object having the lower layer identifier to the object having the upper layer identifier, reducing a range defined by the initial value of the lower layer identifier to a range small enough to be included in a range defined by the initial value of the upper layer identifier and then setting a reduction value thus obtained in association with the lower layer identifier in the root information table, and
in a case where the relationship type information in the relationship information indicates detachment, such as unpacking of or unloading, of the object having the lower layer identifier from the object having the upper layer identifier, restores the reduction value set for the lower layer identifier in the root information table to the initial value of the lower layer identifier.
